(19) United States
(12) Patent Application Publication
(10) Pub. No.: US 2017/0073472 A1
(43) Pub. Date: Mar. 16, 2017

(54) ADDITION CROSS-LINKING SILICONE COMPOSITION WITH A HIGH WATER-ABSORPTION CAPACITY

(71) Applicant: Wacker Chemie AG, Munich (DE)

(72) Inventors: Enno FUNK, Mehring (DE); Torsten GOTTSCHALK-GAUDIG, Mehring (DE)

(21) Appl. No.: 15/121,978

(22) PCT Filed: Feb. 24, 2015
(86) PCT No.: PCT/EP2015/053805

§ 371 Date: Aug. 26, 2016

(30) Foreign Application Priority Data
Feb. 27, 2014 (DE) 102014203613.5

(51) Int. Cl. C08G 77/04; C08K 3/00; C08K 5/00

(52) U.S. Cl. CPC C08G 77/04; C08K 5/0008; C08K 3/0033

(57) ABSTRACT

Reversibly water-absorbtive silicone rubbers are prepared from addition cross-likable organopolysiloxanes by means of a hydrosilylation catalyst, and initially contain anhydrous sodium sulfate, anhydrous magnesium sulfate, or a mixture thereof. The silicone rubbers are capable of absorbing large amounts of water.

### CROSS REFERENCE TO RELATED APPLICATIONS

This application is the U.S. National Phase of PCT Appln. No. PCT/EP2015/053805 filed Feb. 24, 2015, which claims priority to German Application No. 10 2014 203 613.5 filed Feb. 27, 2014, the disclosures of which are incorporated in their entirety by reference herein.

### BACKGROUND OF THE INVENTION

1. Field of the Invention

The present invention relates to an addition cross-linkable silicone composition showing a high, reversible water-absorption capacity after cross-linking, and to the preparation and use thereof.

2. Description of the Related Art

In certain applications of moldings or coatings composed of cured silicone rubber it is important that the silicone rubber is hydrophilic and shows a high capability to absorb water reversibly. For example, while wearing breathing masks or garments composed of cured silicone rubber, water vapor of exhaled air or perspiration has no possibility to escape and this rapidly results in condensation and film formation between the skin and cured silicone rubber. This leads to very poor wearer comfort, particularly over a long time period.

Therefore, there has long been a need to provide silicone compositions, which are curable to silicone rubber, whose surfaces are hydrophilic and which have a high capacity for reversible moisture absorption, that is, the release of the absorbed moisture to the surrounding air is enabled.

The journal article “Effect of Different Water-Soluble Additives on Water Sorption into Silicone Rubber”; Carelli and G. Di Colo, Journal of Pharmaceutical Sciences, Vol. 72, No. 3, March 1983 proposes as a solution to equip silicone compositions with the additives ethylene glycol, glycerol, polyethylene glycols 200, 400 and 6000, polysorbate 80 and lactose. A disadvantage, however, is that these additives, for example, are easily washed out or bleed out of the cured silicone rubber. Long-term use of the cured silicone rubber is therefore not guaranteed.

### SUMMARY OF THE INVENTION

Therefore, the object was to provide silicone compositions which, after curing, have a hydrophilic surface and permit good or improved reversible moisture absorption, without washing out or bleeding out, and which further exhibit good mechanical and rubber-elastic properties. These and other objects are achieved, surprisingly, by addition cross-linkable silicone compositions according to the invention, comprising:
(A) at least one polyorganosiloxane having at least two alkenyl groups per molecule and a viscosity of 0.2 to 1000 Pa·s at 25° C.,
(B) at least one SiH-functional cross-linker,
(C) at least one hydrosilylation catalyst,
(D) at least one hydratable salt, and
(E) at least one filler.

### DETAILED DESCRIPTION OF THE PREFERRED EMBODIMENTS

The polyorganosiloxane (A) comprising alkenyl groups preferably has a composition of the average general formula (1)

R¹ₓR²_{y}SiO_{(4-x-y)/2} (1),
in which
R¹ is a monovalent, optionally halogen- or cyano-substituted C₁-C₁₀-hydrocarbon residue, bonded optionally via an organic divalent group to silicon, comprising aliphatic carbon-carbon multiple bonds,
R² is a monovalent, optionally halogen- or cyano-substituted C₁-C₁₀-hydrocarbon residue bonded via SiC, which is free of aliphatic carbon-carbon multiple bonds
x is a non-negative number such that at least two R₁ residues are present in each molecule, and
y is a non-negative number such that (x+y) is in the range of 1.8 to 2.5.

The alkenyl groups R¹ are accessible to an addition reaction with an SiH-functional cross-linker (B). Alkenyl groups having 2 to 6 carbon atoms are typically used such as vinyl, allyl, methallyl, 1-propenyl, 5-hexenyl, ethynyl, butadienyl, hexadienyl, cyclopentenyl, cyclopentadienyl, cyclohexenyl, preferably vinyl and allyl.

Organic divalent groups, via which the alkenyl groups R¹ may be bonded to the silicon of the polymer chain, consist for example of oxyalkylene units such as those of the general formula (2)

—(O)ₘ[(CH₂)ₙO]ₒ— (2),
in which
m has the value 0 or 1, particularly 0,
n has values from 1 to 4, particularly 1 or 2 and
o has values from 1 to 20, particularly from 1 to 5.

The oxyalkylene units of the general formula (2) are bonded on the left to a silicon atom.

The residues R¹ may be bonded at any position of the polymer chain, in particular, at the terminal silicon atoms.

Examples of unsubstituted residues R² are alkyl residues such as the methyl, ethyl, n-propyl, isopropyl, n-butyl, isobutyl, tert-butyl, n-pentyl, isopentyl, neopentyl and tert-pentyl residues, hexyl residues such as the n-hexyl residue, heptyl residues such as the n-heptyl residue, octyl residues such as the n-octyl residue and isooctyl residues such as the 2,2,4-trimethylpentyl residue, nonyl residues such as the n-nonyl residue, decyl residues such as the n-decyl residue; cycloalkyl residues such as cyclopentyl, cyclohexyl, 4-ethylcyclohexyl or cycloheptyl residues, norbornyl residues and methylcyclohexyl residues; aryl residues such as the phenyl, biphenylyl or naphthyl residue; alkaryl residues such as the o-, m-, and p-tolyl residues and ethylphenyl residues; aralkyl residues such as the benzyl residue, and the alpha- and the β-phenylethyl residue.

Examples of substituted hydrocarbon residues as R² residues are halogenated hydrocarbons such as the chloromethyl, 3-chloropropyl, 3-bromopropyl, 3,3,3-trifluoropropyl and 5,5,5,4,4,3,3-heptafluoropentyl residues and also the chlorophenyl, dichlorophenyl and trifluorotolyl residues.

R² preferably has 1 to 6 carbon atoms. Particular preference is given to methyl and phenyl.

Component (A) may also be a mixture of polyorganosiloxanes comprising different alkenyl groups which differ, for example, in the content of alkenyl groups, the type of alkenyl group or structurally.

The structure of the polyorganosiloxanes comprising alkenyl groups (A) may be linear, cyclic or branched. The content of tri- and/or tetrafunctional units leading to branched polyorganosiloxanes is typically very low, preferably at most 20 mol %, particularly at most 0.1 mol %.

Particular preference is given to using polydimethylsiloxanes comprising vinyl groups, whose molecules correspond to the general formula (3)

(ViMe₂SiO_{1/2})₂(ViMeSiO)ₚ(Me₂SiO)_{q} (3),

where the non-negative integers p and q meet the following relationships: p≧0, 50<(p+q)<20,000, preferably 200<(p+q)<1000, and 0<(p+1)/(p+q)<0.2. In particular, p=0.

The viscosity of the polyorganosiloxane (A) is preferably 0.5 to 500 Pa·s at 25° C., more preferably 1 to 200 Pa·s, and most preferably 1 to 100 Pa·s.

The organosilicon compound (B) comprising at least two SiH functions per molecule preferably has a composition of the average general formula (4)

HₐR³_{b}SiO_{(4-a-b)/2} (4),
in which
R³ is a monovalent, optionally halogen- or cyano-substituted C₁-C₁₈-hydrocarbon residue bonded via Si—C, which is free of aliphatic carbon-carbon multiple bonds and
a and b are non-negative integers,
with the proviso that 0.5<(a+b)<3.0 and 0<a<2, and that at least two hydrogen atoms bonded to silicon are present per molecule.

Examples of R³ are the residues specified for R². R³ preferably has 1 to 6 carbon atoms. Particular preference is given to methyl and phenyl.

Preference is given to the use of an organosilicon compound (B) comprising three or more SiH bonds per molecule. When using an organosilicon compound (B) having only two SiH bonds per molecule, it is recommended to use a polyorganosiloxane (A) having at least three alkenyl groups per molecule.

The hydrogen content of the organosilicon compound (B), which refers exclusively to the hydrogen atoms bonded directly to silicon atoms, is preferably in the range of 0.002 to 1.7% by weight hydrogen, preferably 0.1 to 1.7% by weight hydrogen.

The organosilicon compound (B) preferably comprises at least three and at most 600 silicon atoms per molecule. Preference is given to using organosilicon compounds (B) comprising 4 to 200 silicon atoms per molecule.

The structure of the organosilicon compound (B) may be linear, branched, cyclic or network-like.

Particularly preferred organosilicon compounds (B) are linear polyorganosiloxanes of the general formula (5)

(HR⁴₂SiO_{1/2})_{c}(R⁴₃SiO_{1/2})_{d}(HR⁴₂SiO_{2/2})ₑ(R⁴₂SiO_{2/2})_{f} (5),
where
R⁴ has the definitions of R³ and
the non-negative integers c, d, e and f meet the following relationships: (c+d)=2, (c+e)>2.5<(e+f)<200 and 1<e/(e+f)<0.1.

The SiH-functional organosilicon compound (B) is preferably present in an amount in the cross-linkable silicone composition such that the molar ratio of SiH groups to alkenyl groups is 0.5 to 5, more preferably 1.0 to 3.0.

All known catalysts can be used as hydrosilylation catalysts (C) which catalyze the hydrosilylation reactions taking place during the cross-linking of addition cross-linking silicone mixtures.

The hydrosilylation catalysts (C) used are in particular metals and their compounds from the group of platinum, rhodium, palladium, ruthenium and iridium.

Preference is given to using platinum and platinum compounds. Particular preference is given to those platinum compounds which are soluble in polyorganosiloxanes. The soluble platinum compounds used can be, for example, the platinum-olefin complexes of the formulae (PtCl₂.olefin)₂ and H(PtCl₃.olefin), where preference is given to using alkenes having 2 to 8 carbon atoms such as ethylene, propylene, isomers of butene and octene, or cycloalkenes having 5 to 7 carbon atoms such as cyclopentene, cyclohexene and cycloheptene. Further soluble platinum catalysts are the platinum-cyclopropane complex of the formula (PtCl₂C₃H₆)₂, the reaction products of hexachloroplatinic acid with alcohols, ethers and aldehydes or mixtures of the same or the reaction product of hexachloro-platinic acid with methylvinylcyclotetrasiloxane in the presence of sodium bicarbonate in ethanolic solution. Particular preference is given to complexes of platinum with vinylsiloxanes such as symdivinyltetramethyldisiloxane. Likewise highly suitable are the platinum compounds described in

EP 1 077 226 A1 and EP 0 994 159 A1, the relevant disclosure of which is herein incorporated by reference.

The hydrosilylation catalyst (C) may be used in any desired form, for example, also in the form of microcapsules containing hydrosilylation catalyst, or polyorganosiloxane particles as described in EP 1 006 147 A1, the relevant disclosure of which is also herein incorporated by reference.

The content of hydrosilylation catalysts (C) is preferably selected such that the addition cross-linkable silicone mixture (S) has a Pt content of 0.1 to 200 ppm by weight, particularly 0.5 to 40 ppm by weight.

The term “hydratable salt (D)” signifies that the salt is in a state in which it can absorb additional water by hydration. That is, the salt is used either in its anhydrous form or in a partially hydrated form.

The hydrated salt is preferably of a particulate or powdery nature and may be, for example, alkali metal/alkaline earth metal carbonate, bicarbonate, (poly)phosphate, citrate (anhydrous) or sulfate (anhydrous). Mixtures of two or more hydratable compounds can also be used. For use in direct contact with human skin, only hydratable salts (D) with no risk to health should be used. Therefore, (D) is preferably anhydrous sodium sulfate or anhydrous magnesium sulfate or a mixture thereof.

Preference is given to using 1 to 30% by weight of (D), more preferably 5 to 25% by weight, very particular preference to 10 to 20% by weight.

The addition cross-linkable silicone compositions according to the invention in addition comprise at least one filler (E) as a further component.

Non-reinforcing fillers (E) having a BET surface area of up to 50 m²/g are, for example, quartz, diatomaceous earth, calcium silicate, zirconium silicate, zeolites, metal oxide powders such as aluminum, titanium, iron or zinc oxides or mixed oxides thereof, barium sulfate, calcium carbonate, gypsum, silicon nitride, silicon carbide, boron nitride, glass powder and plastic powder. Reinforcing fillers, that is fillers having a BET surface area of at least 50 m²/g, in particular 100 to 400 m²/g, are for example, fumed silica, precipitated silica, aluminum hydroxide, carbon black such as furnace black and acetylene black and silicon-aluminum-mixed oxides of high BET surface area.

The stated fillers (E) may be hydrophobicized, for example, by treatment with organosilanes, organosilazanes or organosiloxanes, or by etherification of hydroxyl groups to alkoxy groups. One type of filler (E) or also a mixture of at least two fillers (E) may be used. The silicone compositions according to the invention preferably comprise a proportion of filler (E) of preferably at least 3% by weight, more preferably at least 5% by weight, and most preferably at least 10% by weight, and at most 50% by weight.

The silicone compositions according to the invention may optionally comprise further additives as a component (F), at a proportion of 0 to 70% by weight, preferably 0.0001 to 40% by weight. These additives may be, for example, resinous polyorganosiloxanes, which are different from the polyorganosiloxanes (A) and (B), dispersing agents, solvents, adhesion promoters, pigments, dyes, plasticizers, organic polymers, heat stabilizers and inhibitors. These include additives such as dyes and pigments. Furthermore, thixotropic components such as highly dispersed silica or other commercial thixotropic additives may be present as a component. As a further component (F) to improve cross-linking, peroxide may also be present preferably a maximum of 0.5% by weight, more preferably a maximum of 0.3% by weight, and in particular <0.1% by weight.

Further additives may also be present which serve specifically to adjust the processing time, the starting temperature and cross-linking rate of the cross-linking compositions. These inhibitors and stabilizers are very well known in the field of cross-linking compositions.

The present invention further relates to a method for preparing the addition cross-linkable silicone composition according to the invention, a method for preparing the cross-linked silicone rubber of the silicone compositions according to the invention and also the silicone rubber moldings or silicone rubber coatings thus obtainable.

The preparation or compounding of the silicone composition according to the invention is carried out preferably by mixing components (A) and (D) and (E) and optionally (F). The composition according to the invention can be prepared as a 1-, 2- or multi-component composition. The cross-linking, after addition of cross-linker (B) and hydrosilylation catalyst (C), is preferably carried out by heating, preferably at 30 to 250° C., more preferably at at least 50° C., yet more preferably at at least 100° C., and most preferably at 150-210° C.

The silicone rubbers according to the invention thus obtained have the advantage that they have a surprisingly high water absorption and a good permanence of component (D) in the cross-linked silicone rubber (little or no washing out or bleeding out) and also show a very good reversibility of water absorption.

Silicone rubbers according to the invention thus obtained may be used as moldings, for example, respiratory masks, clothing, upholstery or furniture. Silicone rubber coatings according to the invention thus obtained are used, for example, on fibers or fabrics. A further possible use of the cured silicone rubbers according to the invention is their use as a reusable dessicant, for example, in the form of granules or pellets.

All symbols above in the formulae above are defined mutually independently. The silicon atom is tetravalent in all formulae. The sum of all the components of the silicone composition according to the invention add up to 100% by weight.

The viscosities are determined at 25° C. and standard pressure of 1013 hPa. A suitable method is the rotational viscometer procedure according to DIN EN ISO 3219.

### EXAMPLES

In the examples described below, all parts and percentages are by weight unless otherwise stated. Unless stated otherwise, the examples below are conducted at the pressure of the surrounding atmosphere, that is at about 1013 hPa, and at room temperature, that is at 25° C., or at a temperature arising on combining the reactants at room temperature without additional heating or cooling. All viscosity data below refer to a temperature of 25° C. The examples below illustrate the invention without being limited thereto.

The following abbreviations are used:

sec. seconds
min. minutes
rpm revolutions/minute

ELASTOSIL® polyorganosiloxanes are commercially available addition cross-linking 2-component (2K) silicone compositions from Wacker Chemie AG, Munich. Anhydrous sodium sulfate and anhydrous magnesium sulfate were purchased from Merck KGaA, Darmstadt.

### Example 1

9 g (5% by weight) of anhydrous sodium sulfate are weighed together in each case with 85.5 g of ELASTOSIL® 3003/40 A and B components and homogenized on a Speedmixer™ DAC 400 FVZ from Hauschild using the program shown in Table 1:

TABLE 1

| | |
|---|---|
| 5 sec. | 2500 rpm |
| 5 sec. | 800 rpm |
| 10 sec. | 2500 rpm |
| 5 sec. | 800 rpm |
| 10 sec. | 2500 rpm |

This program is used successively 5 times for optimal homogenization of the sample—in between each time the mixture is loosened from the sides and bottom of the mixing vessel using a spatula.

The mixture is vulcanized in a P300 P/M laboratory press from Collin at 165° C. for 5 min and a pressure of 380 N/cm2.

A vulcanized sample is stored in demineralized water for a) 8 hours and b) 700 hours. The weight increase after drying with paper towel is a) 4.1% and b) 39.2%.

### Example 2

The procedure of example 1 is repeated except that 18 g (10% by weight) of anhydrous sodium sulfate are homogenized in each case with 81 g of Elastosil® 3003/40 A and B components.

The mixture is then vulcanized as described in example and a vulcanized sample is stored in demineralized water for a) 8 hours and b) 700 hours. The weight increase after drying is a) 4.5% and b) 78.4%.

### Example 3

The procedure of example 1 is repeated except that 27 g (15% by weight) of anhydrous sodium sulfate are homogenized in each case with 76.5 g of Elastosil® 3003/40 A and B components.

The mixture is then vulcanized as described in example and a vulcanized sample is stored in demineralized water for a) 8 hours and b) 700 hours. The weight increase after drying is a) 5.3% and b) 171.4%.

### Example 4

The procedure of example 1 is repeated except that 9 g (5% by weight) of anhydrous magnesium sulfate are homogenized in each case with 85.5 g of Elastosil® 3003/40 A and B components.

The mixture is then vulcanized as described in example and a vulcanized sample is stored in demineralized water for a) 8 hours and b) 700 hours. The weight increase after drying is a) 4.0% and b) 43.8%.

### Example 5

The procedure of example 1 is repeated except that 18 g (10% by weight) of anhydrous magnesium sulfate are homogenized in each case with 81 g of Elastosil® 3003/40 A and B components.

The mixture is then vulcanized as described in example and a vulcanized sample is stored in demineralized water for a) 8 hours and b) 700 hours. The weight increase after drying is a) 4.6% and b) 54.7%.

### Comparative Example 1 (Non-Inventive)

The procedure of example 1 is repeated except that 18 g (10% by weight) of corn starch are homogenized in each case with 81 g of Elastosil® 3003/40 A and B components.

The mixture is then vulcanized as described in example and a vulcanized sample is stored in demineralized water for a) 8 hours and b) 700 hours. The weight increase after drying is a) 0.8% and b) 2.8%.

### Comparative Example 2 (Non-Inventive)

The procedure of example 1 is repeated except that 18 g (10% by weight) of gelatine are homogenized in each case with 81 g of Elastosil® 3003/40 A and B components.

The mixture is then vulcanized as described in example and a vulcanized sample is stored in demineralized water for a) 8 hours and b) 700 hours. The weight increase after drying is a) 2.9% and b) 16.6%.

1.-2. (canceled)

3. An addition cross-linkable silicone composition, comprising:
(A) at least one polyorganosiloxane having at least two alkenyl groups per molecule and a viscosity at 25° C. of 0.2 to 1000 Pa·s,
(B) at least one SiH-functional cross-linker,
(C) at least one hydrosilylation catalyst,
(D) a hydratable salt, at least one hydratable salt selected from the group consisting of anhydrous sodium sulfate, anhydrous magnesium sulfate and mixtures thereof, and
(E) at least one filler.

4. A method for preparing silicone rubber moldings or silicone rubber coatings, comprising heating the addition cross-linkable silicone composition claim 3 to a temperature of from 30 to 250° C.

5. A reversibly water-absorptive silicone rubber, comprising a cross-linked addition cross-linkable silicone composition of claim 3.
